(19) United States
(12) Patent Application Publication
(10) Pub. No.: US 2007/0229501 A1
(43) Pub. Date: Oct. 4, 2007

(54) Method and system for organizing and rendering multiple geometric parts within a volume graphics data set

(76) Inventors: Vladmir Kouznetsov, Richmond (CA); Keith Reid, Richmond (CA); Filip Petrovic, Vancouver (CA); Andrew C.-H. Woo, Vancouver (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/396,373

(22) Filed: Mar. 31, 2006

(51) Int. Cl. G06T 17/00

(52) U.S. Cl. 345/424

(57) ABSTRACT

Various methods are provided for organizing multiple geometric parts forming an object in 3D voxel data and/or for permitting a user to detach and/or reattach these parts. In one embodiment, the 3D voxel data are organized in two steps. First, a part voxel set is created for each geometric part. Second, a master XZ table is created, which defines geometric locations within multiple part voxel sets based on references. A method allows a user to detach and/or reattach parts in five steps: (a) receiving a user request to detach a first geometric part; (b) retrieving a first part voxel set defining the first geometric part; (c) rendering the first geometric part; (d) updating the master XZ table by replacing references to the first part voxel set with new references; and (e) rendering the rest of the object based on the updated master XZ table.

### FIELD OF THE INVENTION

The present invention relates generally to computer graphics rendering, and more specifically, to rendering and manipulating a volume graphics dataset composed of multiple geometric parts forming an object.

### BACKGROUND OF THE INVENTION

Volume graphics represent a promising way to achieve the degree of realism required for high quality 3D simulations and visualization applications. See, for example, “Myths and Truths of Interactive Volume Graphics,” A. Woo, P. Halmshaw, Interservice/Industry Training, Simulation & Education (I/ITSEC), December 2004. Volume elements (i.e., “voxels”) are the base data used to represent 3D objects within volume graphics. Typically, voxels are simply pixels that have a third coordinate z in addition to x and y coordinates in a Cartesian coordinate system (though voxels may take various other forms, also). In other words, voxels are equally sized cubes that form a discretely defined 3D space. A voxel-based 3D scene can consist of one or more “voxel sets”, each of which in turn consists of one or more voxels.

3D voxel data are rendered to produce a 2D image on a suitable output device, such as a video display or a printer. As used herein, the term “render” means to produce a 2D graphics image on an output device from 3D voxel data, and typically involves creating an image using color, texture, etc., to give the image a realistic look. In typical applications of voxel-based technologies, only one voxel set is rendered, or one voxel set is rendered independently from any other voxel sets.

In other applications, such as in rendering voxel data produced using software available from NGRAIN (Canada) Corp. of Vancouver B.C., Canada, it is often necessary to render and manipulate (sometimes a large number of) multiple voxel sets at a time. Briefly, NGRAIN® technology permits 3D editing of an object, wherein each of multiple parts forming the object can be represented as a voxel set each consisting of one or more voxels. Thus, according to NGRAIN® technology, the entire object starts off by being represented by a single voxel set, and it is possible to manipulate each part independently from each other or from the object as a whole, in 3D space, by splitting off those parts into new voxel sets. This is done for the purpose of generating an exploded view of the object to show the details of its parts, or to peel off an outer part of the object to reveal its inner parts. Various details of the data structure of the NGRAIN® technology are described in commonly owned U.S. patent application Ser. No. 10/333,307, entitled “METHOD, APPARATUS, SIGNALS AND CODES FOR ESTABLISHING AND USING DATA STRUCTURE FOR STORING VOXEL INFORMATION,” which is explicitly incorporated herein by reference.

In rendering multiple voxel sets, each representing a part (or a group of parts) of an object, some of the voxel sets may collide or interpenetrate with each other to create image artifacts. Specifically, when two voxel sets A and B collide with each other in the 3D space, this may create the case of “voxel set interpenetration” wherein certain voxels in voxel set A are in front of voxel set B, while other voxels in voxel set A are behind voxel set B, as seen from a certain viewpoint. Since voxel sets A and B are rendered sequentially one after another, if voxel set A is rendered first before voxel set B, those voxels in voxel set A that are behind voxel set B (and thus should not be visible) are rendered. Likewise, if voxel set B is rendered before voxel set A, then those voxels in voxel set A that are in front of voxel set B (and thus should be visible) are not rendered. This creates “popping” artifacts in the rendered image over an animation, where some image contents that are supposed to be hidden behind other image contents may unnaturally pop up to the front, while some image contents that are supposed to be in front of other image contents may be unnaturally hidden behind other image contents to create holes. Thus, the voxel set interpenetration, if untreated, generally degrades the accuracy of the rendered image. Various methods and systems for treating the voxel set interpenetration, to ensure that only truly visible voxels among multiple voxel sets are rendered, are disclosed in commonly owned U.S. patent application Ser. No. 10/918,024, entitled METHOD AND SYSTEM FOR RENDERING VOXEL DATA WHILE ADDRESSING MULTIPLE VOXEL SET INTERPENETRATION, which is explicitly incorporated herein by reference.

While the methods and systems disclosed in U.S. patent application Ser. No. 10/918,024 are successful in treating the voxel set interpenetration, the rendering speed may be slowed due to the extra processing required to ascertain truly visible voxels among multiple voxel sets, especially when a large number of potentially interpenetrating voxel sets exist. Therefore, in general, it is desirable to limit the number of voxel sets, each representing a part (or group of parts) of an object (e.g., a product), to as small a number as possible. Only when certain parts need to be manipulated independently of other parts do new voxel sets need to be created (on the fly)—in this way, it permits a user (viewer) to be able to manipulate as large a number as possible of parts separately. For example, when the 3D voxel data are used to model a complex machine consisting of numerous parts, it will be desirable to permit users/operators to break apart and manipulate these numerous parts so as to study the internal structure of the machine and/or to virtually simulate its maintenance operation.

The present invention provides various methods and systems for organizing and rendering multiple geometric parts forming a product (or an object) in 3D voxel data.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one aspect of the present invention, a method is provided for organizing multiple geometric parts forming an object in 3D voxel data. The method includes generally two steps. First, an independent voxel set is created for an object. The independent voxel set consists of a geometric data set defining geometric locations of all occupied voxels within the independent voxel set, and an attribute table defining attribute values for all occupied voxels within the independent voxel set. If multiple geometric parts cross (or occupy) the same voxel, only the first geometric part is registered in that voxel. The above set-up is what was implemented in Ser. No. 10/333,307. However, this represents a loss of data, that when one or more parts are detached (and thus new voxel sets are created), holes may be visible on the second (or third, etc.) parts that cross the same voxel. To resolve this, a dependent voxel set is created. The first dependent voxel set consists of a dependent geometric data set defining at least one geometric location of the at least one voxel occupied by the first and second geometric parts in the independent voxel set, and an attribute table defining attribute values for the at least one geometric location as assigned to the second geometric part.

The use of an independent voxel set and one or more dependent voxel sets as described above permits a user to detach and/or reattach multiple geometric parts forming an object in 3D voxel data, while maintaining the data integrity (e.g., graphical integrity) of each of the multiple geometric parts. In one embodiment, a method of permitting a user to detach and/or reattach multiple geometric parts includes generally five steps: (a) receiving a user request to detach a first geometric part from the rest of the object; (b) copying all voxels assigned to the first geometric part in the independent voxel set and in the one or more dependent voxel sets to create a new part voxel set corresponding to the first geometric part; (c) rendering the first geometric part based on the newly created part voxel set corresponding to the first geometric part; (d) removing all voxels assigned to the first geometric part from the independent voxel set or the one or more dependent voxel sets; and (e) rendering the rest of the object based on the independent voxel set. Note that when rendering the independent voxel set, there is a speed advantage in that the dependent voxel sets do not need to be accessed in most cases.

The method may further permit a user to reattach the first geometric part to the rest of the object. To this end, the method includes generally three steps: (f) receiving a user request to reattach the first geometric part to the rest of the object; (g) copying all voxels in the newly created part voxel set corresponding to the first geometric part back into the independent voxel set and the one or more dependent voxel sets, and deleting the newly created part voxel set; and (h) rendering the object based on the independent voxel set.

According to another embodiment of the present invention, another method is provided for permitting a user to detach and/or reattach multiple geometric parts forming an object in 3D voxel data. In this method, a voxel set is predefined for an object, which consists of a geometric data set defining geometric locations of all occupied voxels within the voxel set, and an attribute table defining attribute values including part numbers for all occupied voxels within the voxel set. The method of permitting a user to detach and/or reattach multiple geometric parts includes generally six steps: (a) receiving a user request to detach a first geometric part from the rest of the object; (b) instancing the voxel set to create a first instance voxel set, which is essentially a reference (e.g., a pointer, an index, etc.) to the original voxel set; (c) marking as “hidden” those voxels in the first instance voxel set that do not correspond to the first geometric part; (d) rendering the first geometric part based on the first instance voxel set; (e) marking as “hidden” those voxels in the original voxel set that correspond to the first geometric part; and (f) rendering the rest of the object based on the original voxel set.

The method may further permit the user to reattach the first geometric part to the rest of the object. To this end, the method includes generally three steps: (g) receiving a user request to reattach the first geometric part to the rest of the object; (h) marking as “visible” those voxels in the voxel set that correspond to the first geometric part; and (i) rendering the object based on the voxel set.

In accordance with yet another embodiment of the present invention, another method is provided for organizing multiple geometric parts forming an object in 3D voxel data, including two steps. First, a part voxel set is created for each of the multiple geometric parts. Each part voxel set consists of a part XZ table defining geometric locations of all occupied voxels within the part voxel set, and an attribute table defining attribute values for all occupied voxels within the part voxel set. Thus, multiple part voxel sets are created for the multiple geometric parts, respectively, and the multiple part voxel sets all share the same 3D space. In some embodiments of the present invention, multiple part attribute tables are combined into a single attribute table for the entire object. Second, a master XZ table is created in the same 3D space shared by the multiple part voxel sets. The master XZ table defines geometric locations within the multiple part voxel sets based on references to the geometric locations within the multiple part voxel sets.

In accordance with one aspect of the invention, the references in the master XZ table are arranged in Y arrays in a predefined order of proper detachment of the multiple geometric parts. In accordance with another aspect of the invention, the references in the master XZ table are not arranged in any specific order in Y arrays, and a user may readily re-calculate and adjust the references to control the rendering priority of multiple parts on a part-by-part basis.

Once the 3D voxel data are organized based on the multiple part voxel sets and the master XZ table, as described above, then a method may be performed to permit a user to detach and/or reattach the multiple geometric parts forming an object in the 3D voxel data. The method includes generally five steps: (a) receiving a user request to detach a first geometric part from the rest of the object; (b) retrieving a first part voxel set defining the first geometric part; (c) rendering the first geometric part based on the retrieved first part voxel set; (d) updating the master XZ table by replacing any references to the geometric locations within the first part voxel set defining the first geometric part with new references; and (e) rendering the rest of the object based on the updated master XZ table.

The method may further permit the user to reattach the first geometric part to the rest of the object. To this end, the method includes generally three steps: (f) receiving a user request to reattach the first geometric part to the rest of the object; (g) updating the master XZ table by re-calculating references to refer to the geometric locations within the first part voxel set defining the first geometric part; and (h) rendering the object based on the updated master XZ table.

According to various exemplary embodiments of the present invention, computer-readable tangible media including computer-executable instructions are provided which, when loaded onto a computer, perform the methods of organizing multiple geometric parts forming an object in 3D voxel data and/or the methods of permitting a user to detach and/or reattach the multiple geometric parts from and/or to the object, as described above.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a block diagram of several components of a computing device that may be used to organize and render voxel-based 3D models composed of multiple geometric parts, suitable for use in implementing various methods of the present invention;

FIG. 2A illustrates 3D voxel data representing an object (e.g., an airplane), composed of multiple parts (e.g., a fuselage, two wings each with two flaps, and two stabilizers);

FIGS. 2B and 2C illustrate a XZ table and an attribute table, respectively, which together define a voxel set;

FIGS. 2D and 2E schematically illustrate a method of permitting a user to detach a geometric part from an object that is represented by a voxel set, by copying and deleting voxels in the voxel set;

FIG. 3A schematically illustrates another method of permitting a user to detach a geometric part from an object, by organizing 3D voxel data to consist of an independent voxel set and one or more dependent voxel sets;

FIG. 3B is a flow chart illustrating a method of organizing 3D voxel data to consist of an independent voxel set and one or more dependent voxel sets, as illustrated in FIG. 3A;

FIG. 3C is a flow chart illustrating a method of permitting a user to detach and/or reattach multiple geometric parts in the 3D voxel data, which are organized as illustrated in FIGS. 3A and 3B;

FIG. 4A schematically illustrates another method of permitting a user to detach a geometric part from an object represented by a voxel set, by instancing voxels in the voxel set to create a reference to the voxel set;

FIG. 4B is a flow chart illustrating a method of FIG. 4A;

FIGS. 5A, 5B, and 5C each illustrates a part voxel set, defined by a part XZ table and a part attribute table (not shown), which are organized for use in another method of permitting a user to detach a geometric part from an object represented in 3D voxel data;

FIG. 5D illustrates a master XZ table to be used with the part voxel sets of FIGS. 5A-5C, and how the master XZ table is updated as one or more geometric parts are detached from an object;

FIG. 5E illustrates a combined attribute table for the entire object, including multiple part attribute tables for multiple part voxel sets, respectively;

FIG. 5F is a flow chart illustrating a method of organizing multiple geometric parts forming an object in the 3D voxel data that consist of multiple part voxel sets and a master XZ table; and

FIG. 5G is a flow chart illustrating a method of permitting a user to detach and/or reattach multiple geometric parts forming an object in the 3D voxel data that consist of multiple part voxel sets and a master XZ table.

### DETAILED DESCRIPTION OF THE PRESENT INVENTION

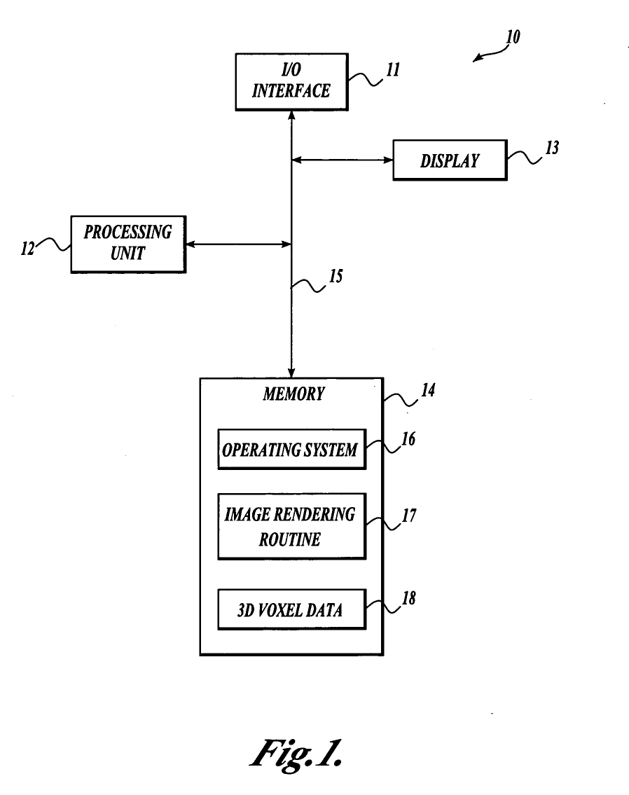

FIG. 1 depicts several of the key components of a computing device 10 that may be used to render 3D voxel data representing an object into a realistic 2D image while permitting a user to manipulate various geometric parts of the object, according to one aspect of the present invention. Those skilled in the art will appreciate that the computing device 10 may include many more components than those shown in FIG. 1. However, it is not necessary that all of these generally conventional components be shown in order to disclose an enabling embodiment for practicing the invention. As shown in FIG. 1, the computing device 10 includes an input/output (“I/O”) interface 11 for connecting to other devices, such as 3D data collection devices. The I/O interface 11 includes the necessary circuitry for such a connection and is constructed for use with the necessary protocols, as will be appreciated by one skilled in the art.

The computing device 10 also includes a processing unit 12, a display 13, and a memory 14 all interconnected along with the I/O interface 11 via a bus 15. The memory 14 generally comprises a random access memory (“RAM”), a read-only memory (“ROM”), and a permanent mass storage device, such as a disk drive, tape drive, optical drive, or combination thereof. The memory 14 stores an operating system 16, an image rendering routine 17 for rendering 3D voxel data to a 2D image, and a 3D voxel database 18 for storing the 3D voxel data to be rendered. In one embodiment of the present invention, the image rendering routine 17 may include routines and techniques disclosed in commonly owned U.S. patent application Ser. Nos. 10/333,307 and 10/918,024, incorporated above. The present invention is generally directed to further optimizing the rendering routines and techniques in 17 to permit further manipulation of different geometric parts of an object represented by 3D voxel data.

It will be appreciated that any of the software components may be loaded from a computer-readable medium into memory 14 of the computing device 10 using a drive mechanism (not shown) for the computer-readable medium, or via the I/O interface 11.

Although an exemplary computing device 10 has been described that generally conforms to a conventional general purpose computing device, those skilled in the art will appreciate that a computing device 10 may be of any of a great number of devices capable of rendering 3D voxel data into a 2D image. However, in at least one embodiment of the present invention, the computing device 10 does not require specialized hardware. Rather, a standard processor as used in a typical laptop, desktop computer or PDA is sufficient. Further, a constrained memory, i.e., a limited amount of memory relative to a typical computer graphics rendering system, is sufficient. Neither specialized hardware nor a significantly large amount of memory is necessary because the voxel data are stored in memory in a data structure that facilitates fast retrieval, storage, deletion, and rendering of voxels. Such a data structure is described in commonly owned U.S. patent application Ser. No. 10/333,307, incorporated above. Accordingly, in one embodiment of the present invention, the computing device 10 requires only 512 megabytes of RAM and a 700 megahertz Intel® Pentium® III processor or an equivalent thereof.

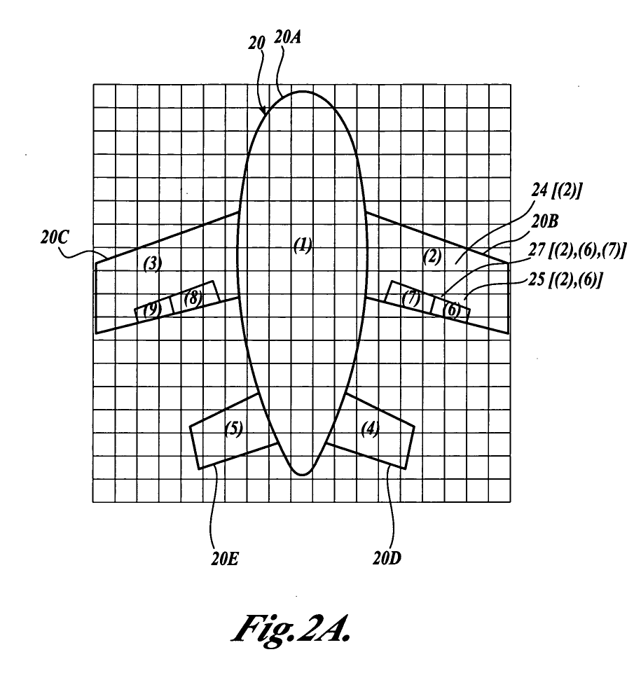

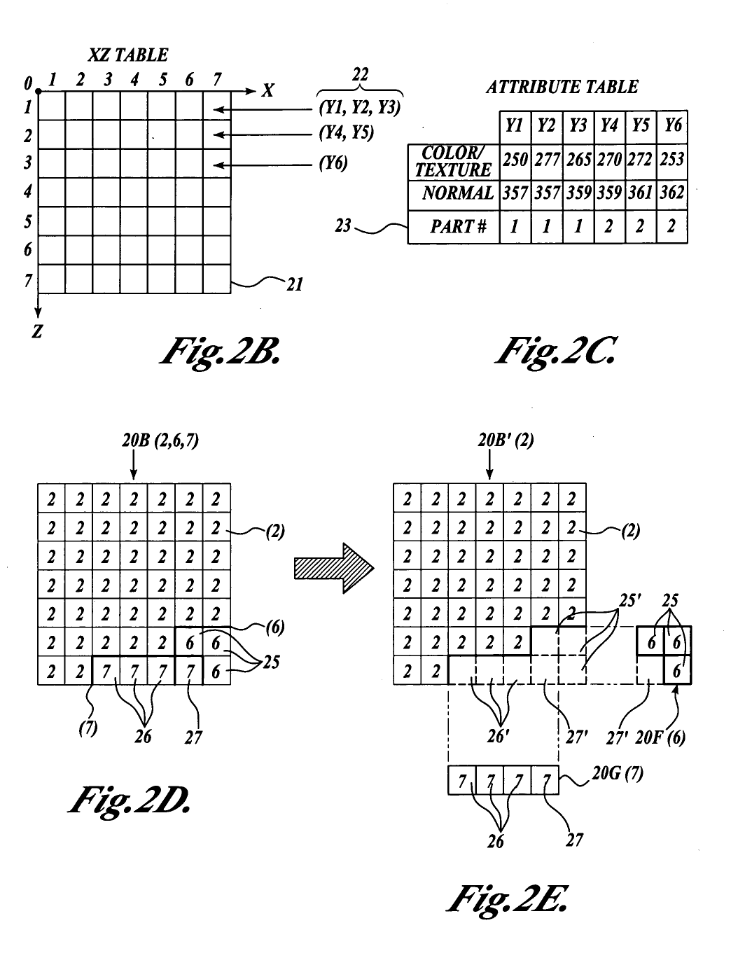

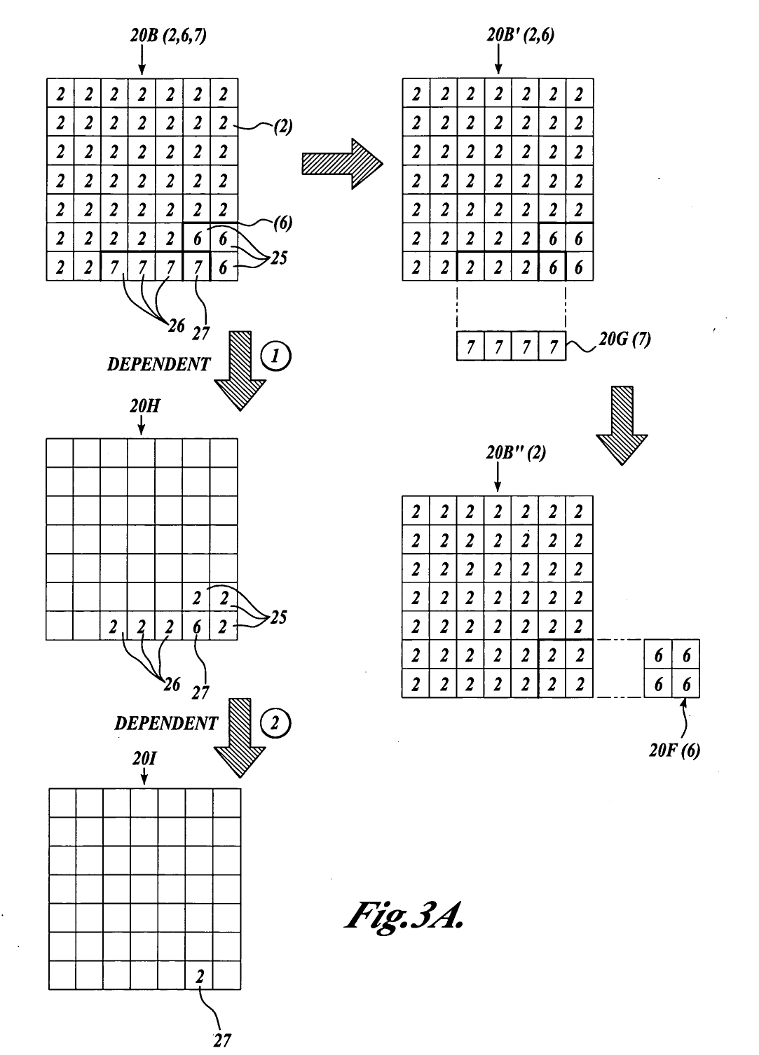

FIG. 2A illustrates 3D voxel data representing an object 20 in the form of an airplane, which includes five parts represented by voxel sets 20A-20E: part (1) (fuselage), parts (2) and (3) (wings), and parts (4) and (5) (stabilizers). Although FIG. 2A is illustrated in 2D for the purpose of clarity, it should be appreciated by one skilled in the art that the actual voxel sets 20A-20E are present in 3D space. Each voxel within a voxel set is defined by its geometric location, for example, in (x, y, z) in Cartesian coordinate system. Each voxel is further associated with a set of attributes, such as its shading information including color/texture, normal vector, part number (e.g., to which part it belongs), etc. Voxels that are occupied by an object (or its part) are termed occupied voxels, whereas voxels that are not occupied are termed empty voxels. Each voxel set may contain occupied voxels and/or empty voxels.

Referring additionally to FIG. 2B, as described in commonly owned U.S. patent application Ser. No. 10/333,307 incorporated above, each voxel set is typically defined by a XZ table (or a XZ base array) 21 which, as the name suggests, is a table of X and Z coordinates of voxels included in the voxel set. For each space defined by its X and Z coordinates, an array of Y coordinates 22 of only the occupied voxels is stored. For example, if an object is hollow inside, only the Y coordinates of the occupied voxels defining the surface of the object are stored in an array. For the purpose of clarity FIG. 2B illustrates only the three arrays of Y coordinates, (Y1, Y2, Y3), (Y4, Y5), and (Y6), corresponding to the X and Z coordinates of (7,1), (7,2), and (7,3), respectively. For each geometric location defined in terms of XZ and Y coordinates within the voxel set, various attribute values (color/texture, normal, part number, etc.) are defined as shown in an attribute table 23 of FIG. 2C. Specifically, for the geometric location of (X, Y, Z)=(7, Y1, 1), the color/texture, normal, and part numbers are defined as (250, 357, 1), respectively, for the geometric location of (X, Y, Z)=(7, Y2, 1), the attribute values are defined as (277, 357, 1), respectively, and so on.

Still referring to FIG. 2A, the wing part (2) further includes smaller geometric parts (6) and (7) each representing a flap, and likewise the other wing part (3) further includes smaller geometric parts (8) and (9) each representing a flap. While it is possible to create an individual voxel set for each of these smaller geometric parts (6)-(9), due to the additional processing required for rendering while addressing the voxel set interpenetration issue discussed above, it may be preferable to generate a “part voxel set” only if and when a user requests to detach (or separate) the geometric part. For example, in the example of FIG. 2A, part voxel sets for the flap parts (6) and (7) may be prepared only upon the user's request to detach these flap parts from the wing part (2) represented by the voxel set 20B. Thus, when the user re-attaches the flap parts (6) and (7) to the wing part (2), the part voxel sets created for the flap parts (6) and (7) are merged back into the voxel set 20B and thus only the voxel set 20B remains after re-attachment. This way, until the flap parts (6) and (7) need to be detached, they remain part of the single voxel set 20B, which can automatically address occlusion culling during rendering (i.e., no extra processing is required to determine which voxels are truly visible and thus should be rendered).

One approach to creating a part voxel set for a geometric part, which is being detached from an object, is to make a copy of a portion of the original voxel set corresponding to the part to be detached as a part voxel set, and then to delete those voxels corresponding to the detached part from the original voxel set. FIGS. 2D and 2E schematically illustrate this approach. FIG. 2D show the voxel set 20B representing the wing part (2), from which the flap parts (6) and (7) are to be detached to be represented by newly created part voxel sets 20F and 20G, respectively (see FIG. 2E). The number assigned to each voxel (“2,” “6,” and “7”) is a part number of the voxel. The part voxel set 20F for the flap part (6) may be created by first copying the voxels corresponding to the flap part (6) 25 (total 3 voxels) in the original voxel set 20B, and by deleting those copied (6) voxels from the original voxel set 20B to thereby form a modified voxel set 20B′. Similarly, the part voxel set 20G for the flap part (7) may be created by first copying the voxels corresponding to the flap part (7) 26 and 27 (total 4 voxels) in the original voxel set 20B, and by deleting those copied voxels from the original voxel set 20B to thereby form the modified voxel set 20B′.

The voxel copying/deleting approach described above, however, is computationally intensive. Also, since one voxel is assigned a single part number, if one voxel is in fact occupied (or shared) by multiple parts, then some of these parts when detached from an object (or the object from which these parts are detached) may lose those voxels (or more specifically; their attribute values) that are not assigned their own part number. For example, in FIG. 2A, a voxel 24 is occupied by only the wing part (2), and therefore this voxel is properly assigned the part number (2). On the other hand, a voxel 25 is shared by both the wing part (2) including the flap part (6) and the flap part (6) itself. If, for example, the voxel 25 is assigned the part number (6), the part voxel set 20F created for the flap part (6) will include the voxel 25 as copied from the original voxel set 20B, but the same voxel 25 will be deleted from the original voxel set 20B representing the wing part (2). Thus, referring to FIG. 2E, the modified voxel set 20B′ includes holes (spaces) 25′ that are missing the voxels for the wing part (2). Similarly, if the voxels 26 and 27 in the original voxel set 20B are assigned the flap part number (7) even though they are also occupied by the wing part (2), then when the flap part (7) is detached from the wing part (2) to be represented by the new part voxel set 20G, all of these voxels 26 and 27 will be copied onto the part voxel set 20G but they are deleted from the original voxel set 20B, to thereby create holes (spaces) 26′ and 27′ in the modified voxel set 20B′ that should otherwise be occupied by the wing part (2). Still referring to FIG. 2A, the voxel 27 is occupied (or shared) by the wing part (2), the flap part (6), and the flap part (7). If the voxel 27 is assigned the part number (7), as illustrated in FIG. 2E, the voxel 27 will be properly copied onto the part voxel set 20G for the flap part (7), but will be missing from each of the modified voxel set 20B′ for the wing part (2) and the part voxel set 20F for the flap part (6).

This problem is referred to herein as the “Swiss-cheese” problem, wherein a new part voxel set created from an original voxel set, or the original voxel set from which the new part voxel set has been deleted (or copied), is missing one or more voxels to thereby create one or more unnatural holes in a rendered image.

According to one aspect of the present invention, a method is proposed to address the Swiss-cheese problem when detaching parts from an original voxel set. According to the method, for the original (independent) voxel set, one or more “dependent” voxel sets are created. The dependent voxel sets define the geometric location and attribute values for each of the voxels belonging to additional parts that reside in (or occupy) the same voxel. Thus, by traversing the dependent voxel sets, it is possible to determine and retrieve the geometric location and attribute values of all voxels for each part as it is detached from an object, and also for the object from which the part has been detached.

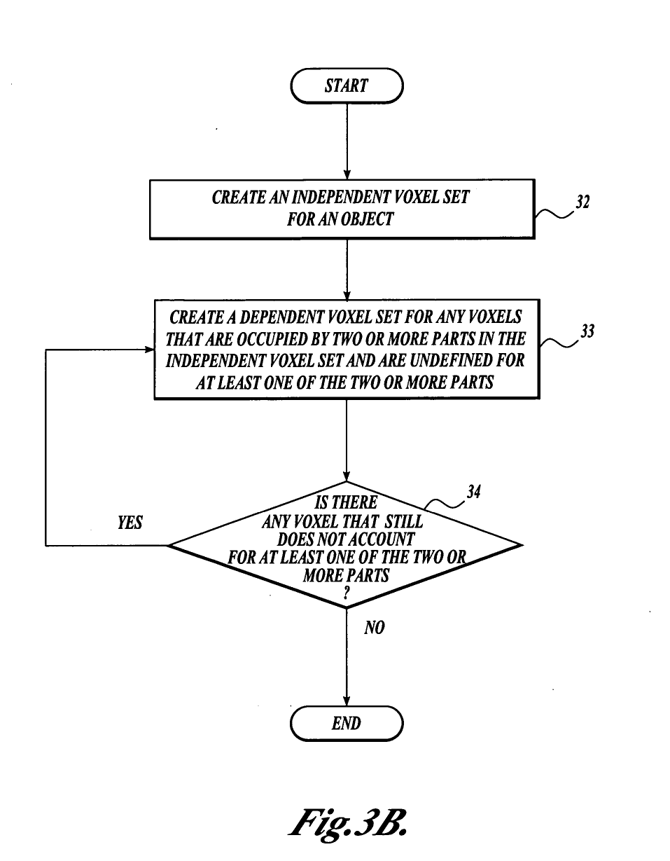

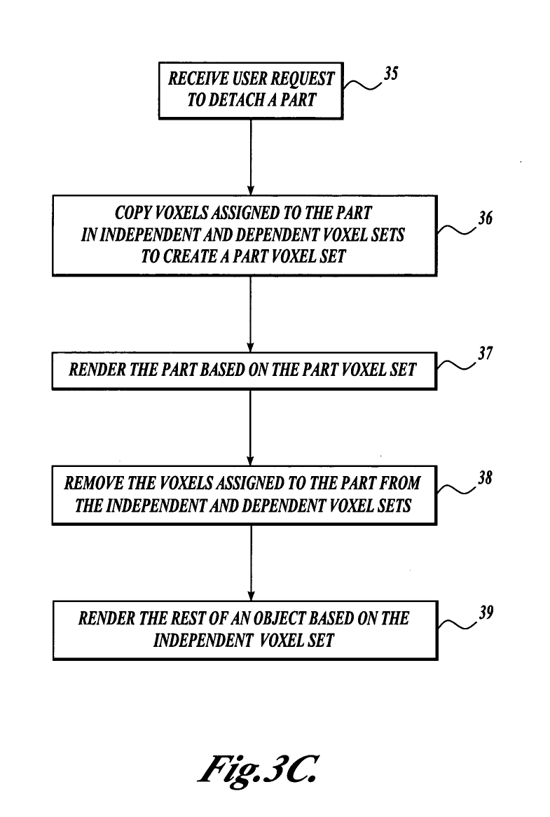

FIG. 3A illustrates the independent voxel set 20B representing the combination of the wing part (2) and the flap parts (6) and (7), a first dependent voxel set 20H, and a second dependent voxel set 201. The first and second dependent voxel sets 20H and 20I are constructed to define all voxels that are occupied (shared) by two or more parts in the original, independent voxel set. Specifically, following the example of FIGS. 2A-2E, the independent voxel set 20B is identical to the voxel set 20B of FIG. 2D. The first dependent voxel set 20H assigns the voxels 26 to the wing part (2) and thus associates these voxels 26 with the attribute values (color/texture, normal, etc.) of the wing part (2). In the original voxel set 20B, the voxels 26 are shared by the wing part (2) and the flap part (7), but are designated to belong to the flap part (7) and thus are not associated with any attribute values of the wing part (2).

It should be noted that each of the voxel set 20B, the first dependent voxel set 20H, and the second dependent voxel set 20I is also defined by a XZ table and an attribute table, described above in reference to FIGS. 2B and 2C above. Thus, based on their respective XZ tables and attribute tables, the attribute values for each voxel at a particular location as belonging to a certain part can be readily determined based on the part number of the voxel (as stored in the attribute table). For example, in the first dependent voxel set 20H, the attribute values for the voxels 26 that are designated to belong to the wing part (2) can be found by referencing the XZ table and attribute table of the first dependent voxel set 20H. It should be noted that since the present 3D data structure does not incur any extra memory nor processing overhead with empty voxels, the extra memory required to store dependent voxel sets tends to be small (since there tends to be much fewer occupied voxels in the dependent voxel sets).

In FIG. 3A, the first dependent voxel set 20H also assigns the voxel 27 to the flap part (6) and thus associates the voxel 27 with the attribute values of the flap part (6). In the original voxel set 20B, the voxel 27 is shared by the wing part (2), the flap part (6), and the flap part (7), but is designated to belong to the flap part (7) and thus is not associated with any attribute values of the wing part (2) or of the flap part (6). Thus, it is possible to assign the voxel 27 in the first dependent voxel set 20H to either the wing part (2) or the flap part (6). In the illustrated example, the voxel 27 is assigned to the flap part (6) based on a predefined real-life order of properly detaching various parts from an object represented by the voxel set 20B. For example, it may be desirable to detach the flap part (7) first and then the flap part (6) from the wing part (2) for the purpose of servicing the various parts of the wing part (2) in reality. Thus, in the illustrated example, the voxel 27 in the first dependent voxel set 20H is assigned to the flap part (6) because the flap part (6) needs to be detached first to reveal the underlying wing part (2). The first dependent voxel set 20H also assigns the voxels 25 to the wing part (2) and thus associates the voxels 25 with the attribute values of the wing part (2). In the original voxel set 20B, the voxels 25 are shared by the wing part (2) and the flap part (6), but are designated to belong to the flap part (6) and therefore are not associated with any attribute values for the wing part (2).

The second dependent voxel set 201 assigns the voxel 27 to the wing part (2) and thus associates the voxel 27 with the attribute values of the wing part (2). In the original voxel set 20B, the voxel 27 is shared by the wing part (2), the flap part (6), and the flap part (7), but is designated to belong to the flap part (7) and thus is not associated with any attribute values for the wing part (2) or the flap part (6). In the first dependent voxel set 20H, the voxel 27 is designated to belong to the flap part (6) and thus is not associated with any attribute values for the wing part (2).

It should be understood that, although the embodiment of the present invention using independent/dependent voxel sets is described above based on a geometric data set comprised of a XZ table and an attribute table, other types of geometric data sets may be used to define geometric locations of all occupied voxels within independent/dependent voxel sets and also their associated attribute values. For example, an octree (instead of a grid-like structure as in a XZ table) may be used to represent voxel data. As another example, occupancy data comprised of a 1-bit 3D-arary may be used, with each occupied bit being associated with a reference (e.g., pointer) to its attribute values, such as color/texture values, normal vector values, part numbers, etc.

FIG. 3B is a flow chart illustrating a method of organizing 3D voxel set data including an independent voxel set and one or more dependent voxel sets. In step 32, an independent voxel set is created to represent an overall object. In step 33, a first dependent voxel set is created for any voxels that are occupied by two or more parts in the independent voxel set and are thus undefined for at least one of the two or more parts. In step 34, it is determined whether there is any voxel that still has at least one of the two or more parts that reside in (or occupy) the same voxel but are not accounted for in the existing dependent voxel sets. If so, returning to step 33, another dependent voxel set (e.g., a second dependent voxel set) is created for those voxels. The steps 33 and 34 are repeated until all voxels account for all of the multiple parts that reside in the same voxels.

FIG. 3C is a flow chart illustrating one example of a routine of permitting a user to attach and/or reattach multiple parts forming an object arranged in 3D voxel data consisting of an independent voxel set and one or more dependent voxel sets. In step 35, the routine receives user request to detach a part. In step 36, voxels assigned to the part are copied from both the independent and any of the dependent voxel sets to create a part voxel set. In step 37, the part is rendered based on the created part voxel set. In step 38, the voxels assigned to the part are removed from the independent voxel set and any dependent voxel sets. In step 39, the rest of the object is rendered based on the independent voxel set.

There are several implementation embodiments of step 39. In one embodiment, the voxel information in the dependent voxel set(s) can be shifted (or moved) up one level, to essentially fill in any empty voxels created in the independent voxel set after a part has been detached from an object. Thus, during rendering of the object from which the part has been detached, only the independent voxel set needs to be traversed. This embodiment has the advantage of fast rendering speed, but its detachment speed may suffer slightly from the additional processing required to shift the voxel information up one level. In another embodiment, no voxel shifting is performed, and the object from which the part has been detached is rendered based on traversing not only the independent voxel set but also any dependent voxel set(s) including voxels that account for the object (from which the part has been detached). This embodiment has the advantage of fast detachment speed, but its rendering speed may suffer slightly from the additional traversing of dependent voxel set(s) required to render the object. It should be understood that one skilled in the art can implement either of these embodiments, or their variations, to perform step 39 of FIG. 3C, depending on each application. Thus, step 39 should be understood to require only that the rest of the object (from which the part has been detached) is rendered based at least on the independent voxel set.

The routine is described in further reference to FIG. 3A. Specifically, when the flap part (7) is to be detached, the voxels corresponding to the flap part (7) are copied to form a new part voxel set 20G. Then, those copied voxels corresponding to the flap part (7) are deleted from the original voxel set 20B. In one embodiment in which the voxels from any dependent voxel sets are shifted up one level, as described above, when rendering the remaining object consisting of the wing part (2) and the flap part (6), the routine traverses only the original independent voxel set 20B. In this embodiment, the routine forms a modified independent voxel set 20B′, which is a combination of the independent voxel set 20B (including holes) and the first dependent voxel set 20H that complement each other. Specifically, for the four locations 26 and 27 previously occupied by the voxels corresponding to the flap part (7) in the voxel set 20B, the three voxels 26 corresponding to the wing part (2) and the voxel 27 corresponding to the flap part (6) are retrieved (or shifted) from the first dependent voxel set 20H and combined with the original voxel set 20B to thereby jointly represent the remaining object consisting of the wing part (2) and the flap part (6). In another embodiment in which the voxels from the dependent voxel sets are not shifted up one level, the routine for rendering the remaining object traverses not only the original voxel set 20B, but also the first dependent voxel set 20H and the second dependent voxel set 201 (if necessary) to obtain voxel information to fill in any spaces in the original voxel set 20B left by those voxels copied to form the new part voxel set 20G.

Likewise, when the flap part (6) is further detached from the wing part (2), the voxels corresponding to the flap part (6) are copied from the original voxel set 20B (or 20B′) and also from the first dependent voxel set 20H (and the second dependent voxel set 201 if necessary) to form a new part voxel set 20F. Then, the voxels corresponding to the flap part (6) are deleted from the original voxel set 20B (or 20B′) and also from the first dependent voxel set 20H. In one embodiment in which the voxels from any dependent voxel sets are shifted up one level, as described above, when rendering the remaining wing part (2), the routine traverses only the original independent voxel set. In this embodiment, the routine forms a modified independent voxel set 20B”, which is a combination of the independent voxel set 20B (including holes), the first dependent voxel set 20H (also including holes), and the second dependent voxel set 20I, which all complement each other. Specifically, for the three locations 25 previously occupied by the voxels corresponding to the flap part (6) in the original voxel set 20B, the three voxels 25 corresponding to the wing part (2) are retrieved (or shifted) from the first dependent voxel set 20H. Further, for the location 27 originally occupied by the wing part (7) in the original voxel set 20B, the voxel 27 corresponding to the wing part (2) is retrieved from the second dependent voxel set 201. Thus, the modified independent voxel set 20B″ completely represents the remaining wing part (2). In another embodiment in which the voxels from the dependent voxel sets are not shifted up one level, the routine for rendering the remaining object (the wing part (2) in this case) traverses not only the original voxel set 20B (including holes), but also the first dependent voxel set 20H (now including holes) and the second dependent voxel set 201 to obtain voxel information to fill in any spaces in the original voxel set 20B.

When rendering the entire wing part (2) including the flap parts (6) and (7), the single voxel set 20B needs to be rendered and thus the rendering speed is very fast. Only when the flap parts (7) and/or (6) are to be detached from the wing part (2), the part voxel sets for the flap parts (7) and/or (6) are created based on copying and deleting of the corresponding voxels in the original voxel set (20B in this case) and in any dependent voxel sets (e.g., 20H and 201 in FIG. 3A). In various exemplary embodiments of the present invention, the routine traverses (prior to rendering or at the time of rendering) not only the original independent voxel set but also a series of dependent voxel sets to ensure that all parts detached from the original object, and also the remaining object itself, will not have any missing voxel. Once the part voxel sets for the newly detached parts are created, these part voxel sets can be rendered very fast. Note that all of the part voxel sets are created from the original voxel set (20B in this case) and thus share the same 3D space as the original voxel set 20B.

While the use of the dependent voxel sets described above solves the Swiss-cheese problem and permits fast rendering, the voxel copying/deleting operation required to create new part voxel sets when detaching parts is still computationally intensive to slow down the part detachment speed.

Therefore, according to another aspect of the present invention, a different method is proposed to increase the part detachment speed. According to the method, for each voxel set, one or more instance voxel sets are created. As used herein, an instance voxel set is a 3D data set that is derived by applying a 4×4 transformation matrix to the original voxel set. Thus, each instance voxel set is a reference to the original voxel set, with an extra bit array for occupied voxels, where a bit per occupied voxel is used to indicate whether it is visible or hidden (for this instance voxel set). The term “reference” is used herein to mean any method or means of referencing to other object(s) in a computer program including, but not limited to, indexing, pointing, etc. The process of creating an instance voxel set is herein referred to as “instancing”. Because instancing involves creation of the visible/hidden bit-array, and does not involve actual copying or deleting of voxels in the original voxel set, instancing is almost immediate. Also, instancing does not require much memory space as it uses only the original (source) voxel set and does not involve duplicating any of the voxels in the original voxel set, requiring just the additional visible/hidden bit-array. Once an instance voxel set for a certain part is created, only the voxels tagged as “visible” in the original voxel set corresponding to the part remain active, and all other voxels that are “hidden” are considered irrelevant voxels.

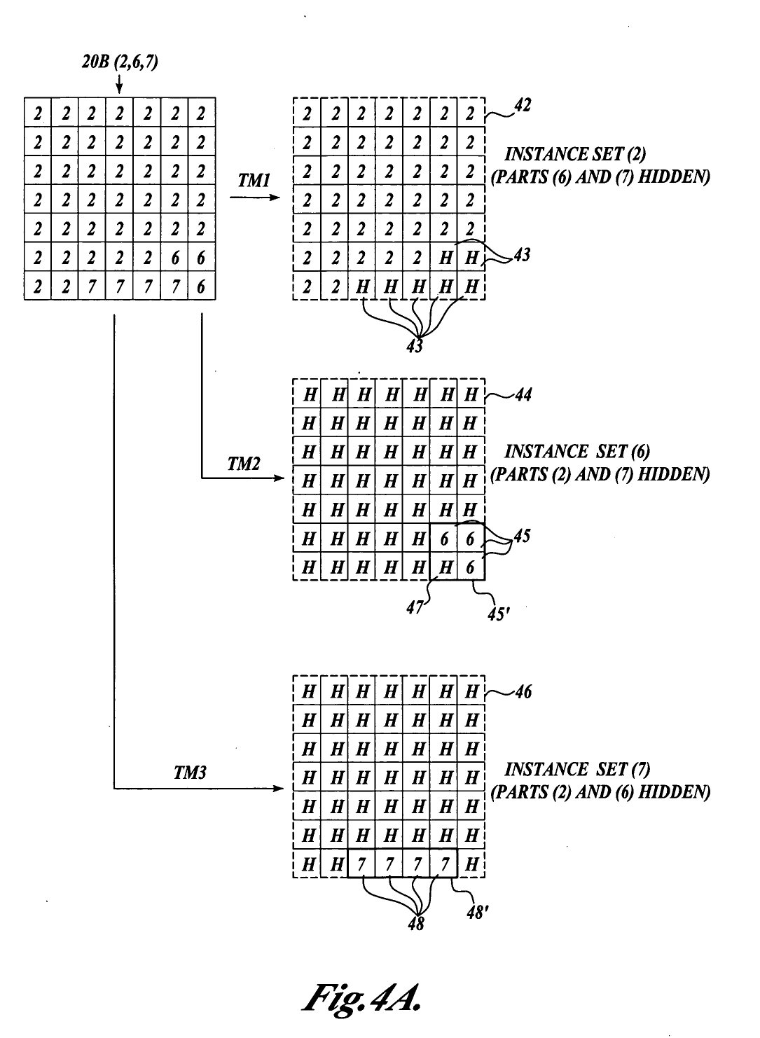

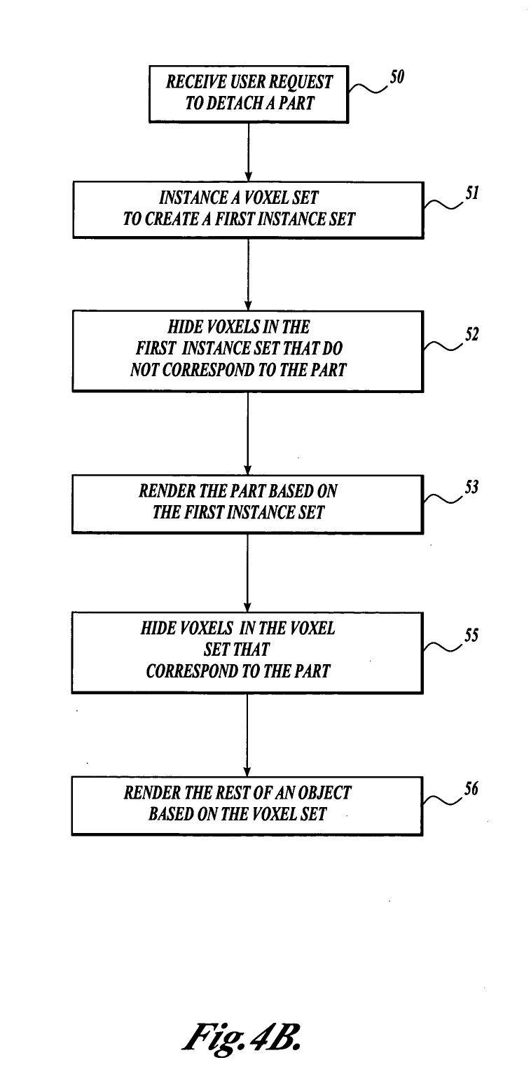

Specifically, FIG. 4A schematically illustrates the process of instancing based on the original voxel set 20B, in accordance with one embodiment of the invention. Using transformation matrices (TM) 1, 2, and 3, instance voxel sets for the wing part (2) 42, the flap part (6) 44, and the flap part (7) 46 are created, respectively, all based on the original voxel set 20B. In the instance voxel set for the wing part (2) 42, any voxels 43 corresponding to the flap parts (6) and (7) are hidden (those voxels are marked with “H”). Similarly, in the instance voxel set for the flap part (6) 44, only the voxels 45 corresponding to the flap part (6) remain “visible”, and the voxels corresponding to the wing part (2) and the flap part (7) are hidden. In the instance voxel set for the flap part (7) 46, only the voxels 48 corresponding to the flap part (7) remain visible, and the voxels corresponding to the wing part (2) and the flap part (6) are hidden. Note that the instance voxel sets 42, 44, and 46 are not actual voxel sets defined by XZ tables and attribute tables, unlike the original voxel set 20B that is defined by a XZ table and an attribute table. Thus, the instance voxel sets 42, 44, and 46 are shown enclosed in broken lines in FIG. 4A.

In accordance with some embodiments of the present invention, this approach can be further optimized by only storing and considering the bit-array information for a tighter bounding box. For example, for TM2, one can store a bounding box that encompasses all of part (6), which in FIG. 4A, is a 2×2 bounding box 45′. When rendering, one can also only consider this 2×2 bounding box 45′, so as not to spend the extra time nor memory for data outside this 2×2 bounding box. This would be of significant advantage for parts such as part (6) (TM2) and part (7) (TM3, which comes out to be a 1×4 bounding box 48′), but does not have an advantage for part (2) (TM1) because the instance voxel set for part (2) has the same size as its bounding box.

In various exemplary embodiments of the present invention, a “main” instance voxel set is created to represent the main object from or to which various geometric parts are detached or re-attached. The creation of a main instance voxel set is advantageous in keeping the number of instanced sets low, to thereby minimize the computational load required for rendering multiple instance voxel sets. In the example of FIG. 4A, the instance voxel set (2) may be considered as a “main” instance voxel set that represents the main object from which the geometric parts (6) and (7) have been detached.

FIG. 4B is a flow chart illustrating one exemplary method of permitting a user to detach and/or reattach multiple geometric parts forming an object in 3D voxel data, which consist of an original voxel data set and multiple instance voxel sets. In step 50, the routine receives a user request to detach a part. In step 51, instancing of the original voxel set is carried out to create a first instance voxel set. In step 52, any parts other than the detached part in the first instance voxel set are marked as “hidden”. In step 53, the detached part is rendered based on the first instance voxel set. In step 55, all voxels in the main (original) voxel set that correspond to the detached part are marked as “hidden”. In step 56, the rest of the object (i.e., the remaining object after that part has been detached) is rendered based on the voxel set.

It should be understood that although the embodiment of the present invention using instancing is described above based on a geometric data set comprised of a XZ table and an attribute table, other types of geometric data sets may be used to define geometric locations of all occupied voxels and also their associated attribute values. For example, an octree may be used to represent voxel data. As another example, occupancy data comprised of a 1-bit 3D-arary may be used, with each occupied bit being associated with a reference (e.g., pointer) to its attribute values.

While the creation of instance voxel sets is almost immediate, and thus the part detachment speed is significantly improved, rendering of instance voxel sets may be relatively slow. This is because each time an instance voxel set is to be rendered, all occupied voxels within the instance voxel set need to be processed to determine which voxels are to be visible and which voxels are to be hidden. For example, in the case of the instance voxel set for the flap part (6) 44, even though three voxels 45 associated with the flap part (6) result in rendering of those voxels in the original voxel set 20B, all the other occupied voxels marked with “H” in the instance voxel set 44 need to be processed to determine whether those voxels are hidden or not. As described above, this can be improved by the use of a bounding box in the case of part (6), but such is of no help with respect to part (2) or other parts that may have large bounding boxes. Further, the instancing method does not address the Swiss-cheese problem discussed above. For example, the instance voxel set for the wing part (2) 42 is missing seven voxels 43 marked with “H” (hidden), and thus upon rendering, an image of the wing part (2) will include a hole corresponding to these missing voxels 43. Similarly, an image of the flap part (6) based on the instance voxel set for the flap part (6) 44, when rendered, will include a hole corresponding to the missing voxel 47. This can be addressed by creating dependent voxel sets, as in the previously described embodiment, and further by creating additional visible/hidden tagged bit-arrays for the dependent voxel sets. This method, however, may increase the complexity of the instancing approach as well as the runtime computational expense.

In accordance with a further aspect of the present invention, a method is proposed to improve the part detachment speed that does not require the voxel copying/deleting operation described above, while at the same time maintaining a reasonably fast rendering speed and also addressing the Swiss-cheese problem. According to the method, for each part forming a product (or an object), a part voxel set is defined in terms of a part XZ table and a part attribute table. Then, a master XZ table is created, which includes references to the locations within the part voxel sets. Similar to a regular XZ table described above in reference to FIG. 2B, a master XZ table refers to a Y array for each of the space defined by X and Z coordinates. Unlike the regular XZ table, however, the master XZ table includes references to the Y coordinates (in Y arrays) associated with various part XZ tables, as opposed to the Y coordinates associated with a single XZ table. Note that the master XZ table does-not store any attribute information.

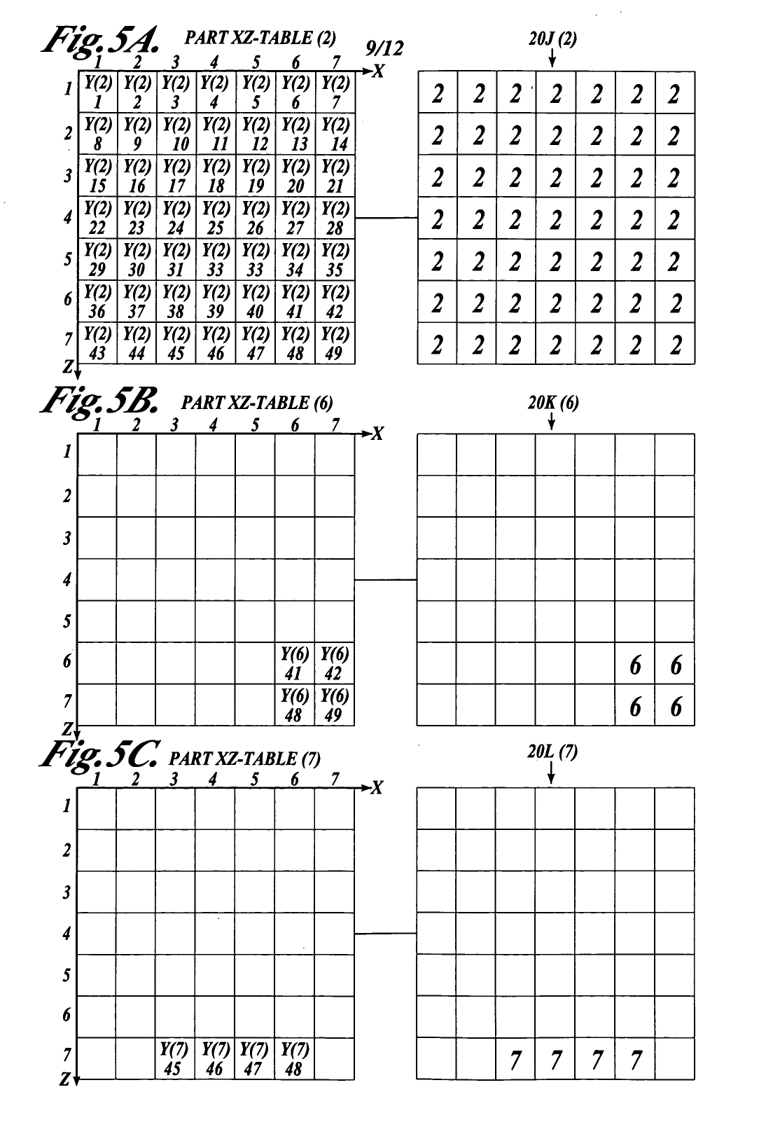

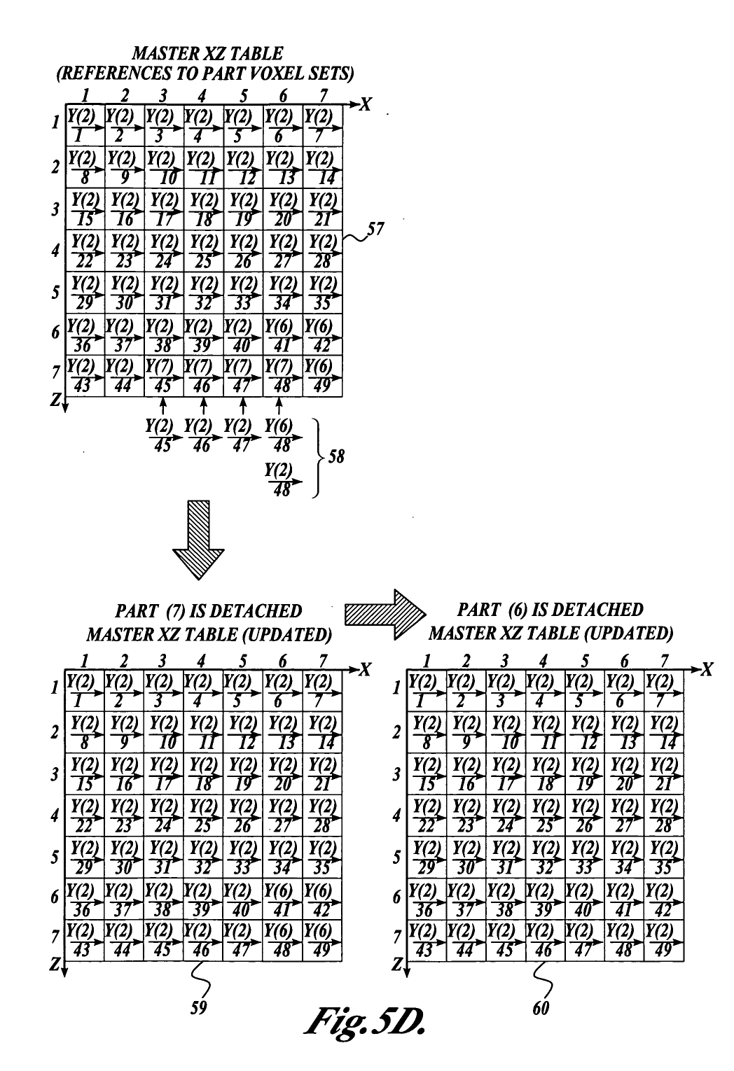

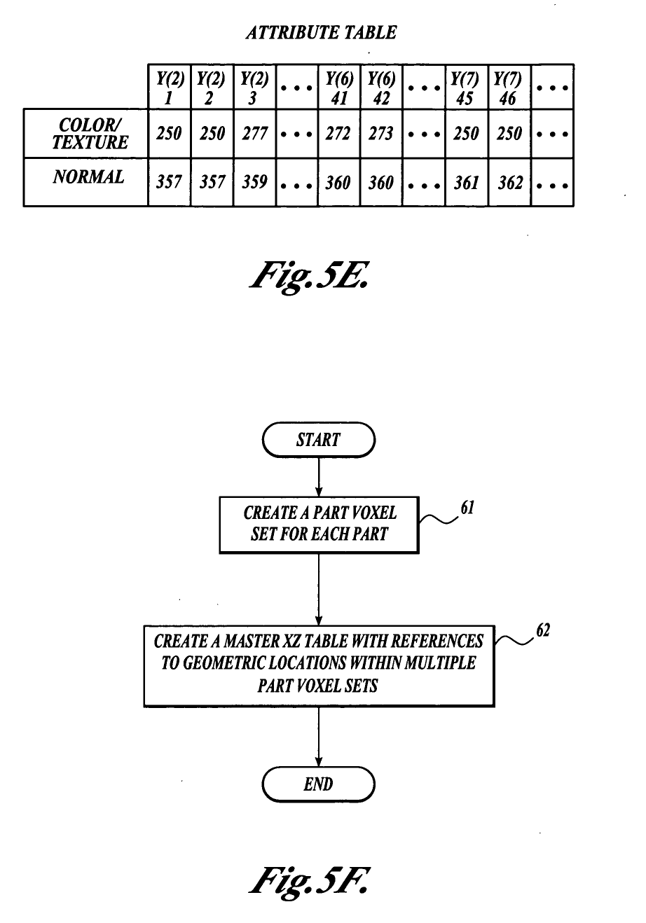

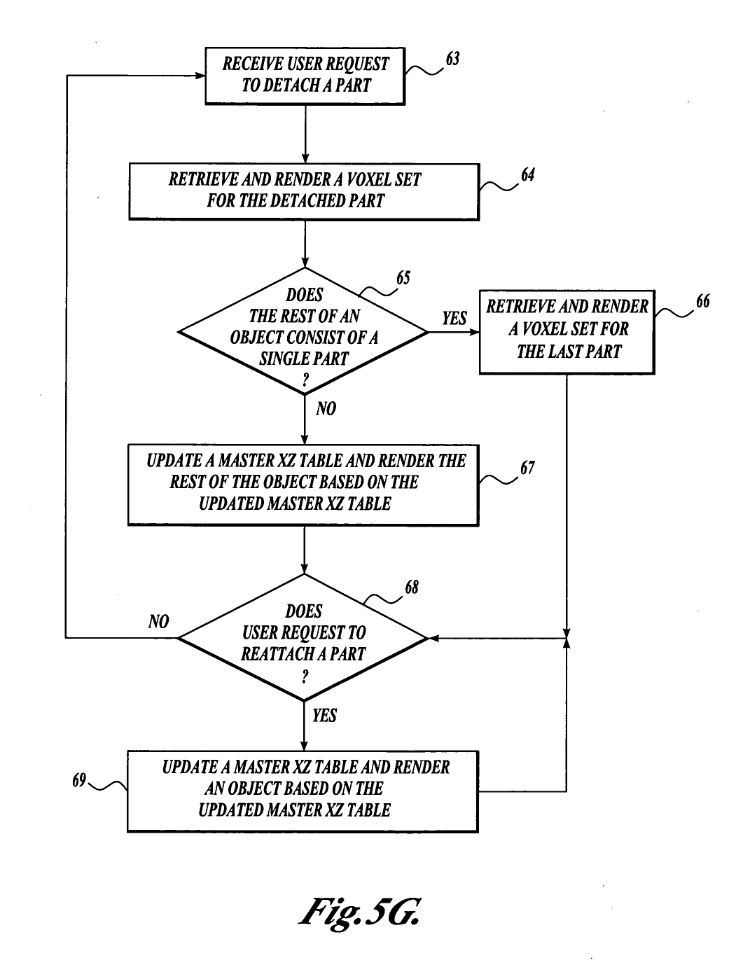

FIGS. 5A-5C illustrate a part voxel set 20J for the wing part (2), a part voxel set 20K for the flap part (6), and another part voxel set 20L for the flap part (7), respectively. Each of these part voxel sets 20J, 20K, and 20L is defined by a part XZ table and a part attribute table (not shown), and completely defines the corresponding part, i.e., all the voxels included in each part are associated with attribute values as stored in the corresponding part attribute table. As illustrated, each of the part XZ tables refers to an array of Y coordinates of the occupied voxels included in the corresponding voxel set. (For clarity, each array is illustrated to include only one Y coordinate value for each XZ location). Specifically, a part XZ table for the voxel set 20J for the wing part (2) refers to Y coordinates, Y(2)1, Y(2)2, Y(2)3, . . . Y(2)47, Y(2)48, Y(2)49, for XZ coordinates of (1,1), (2,1), (3,1), . . . , (5,7), (6,7), (7,7), respectively. Similarly, a part XZ table for the voxel set 20K for the flap part (6) refers to Y coordinates, Y(6)41, Y(6)42, Y(6)48, Y(6)49, for XZ coordinates of (6,6), (7,6), (6,7), (7,7), respectively. A XZ table for the voxel set 20L for the flap part (7) refers to Y coordinates, Y(7)45, Y(7)46, Y(7)47, Y(7)48, for XZ coordinates of (3,7), (4,7), (5,7), (6,7), respectively. Each of the geometric locations defined by XZ and Y coordinates within each voxel set is then associated with attribute values as stored in the corresponding attribute table.

In various exemplary embodiments of the present invention, multiple part attribute tables are combined into a single attribute table for the entire object, as shown in FIG. 5E. In FIG. 5E, for Y coordinates, Y(2)1, Y(2)2, Y(2)3, . . . of the voxel set 20J, attribute values (e.g., color/texture, normal) are defined. Similarly, for Y coordinates, Y(6)41, Y(6)42, . . . of the voxel set 20K, and for Y coordinates, Y(7)45, Y(7)46, . . . of the voxel set 20L, attribute values are defined. Note that an attribute value specifying a part number, as included in the attribute table of FIG. 2C, could be omitted because the part number information is implicitly defined in the combined attribute table of FIG. 5E, where each of Y coordinates refers to a Y coordinate of a specific part voxel set.

Note that all of these part voxel sets as shown in FIGS. 5A-5C, as well as the master XZ table to be described below, share the same 3D space. Note also that, in practice, it may be preferable to have a tight bounding box that refers to the part, so that the part XZ table does not need to account for the empty space outside this tight bounding box. For example, part (6)'s bounding box is a 2×2 box and part (7)'s bounding box is a 1×4 box. This can save processing time as well as memory usage.

FIG. 5D illustrates a master XZ table 57 and how it is updated as various parts are detached from an object. As briefly discussed above, the master XZ table 57 is a collection of references to the XZ and Y coordinates defined in the part voxel sets 20J, 20K, and 20L. In various exemplary embodiments of the present invention, the master XZ table is constructed to refer to the various parts represented by the voxel sets 20J, 20K, and 20L, in a manner corresponding to how these parts are actually (physically) arranged in real life. Specifically, the master XZ table 57 includes arrays of “references” to the Y coordinates associated with various part XZ tables, and the references may be arranged in the order of proper detachment of various parts. For example, in the present example, the flap part (7) is to be detached first, and then the flap part (6) is to be detached from the wing part (2) in a proper maintenance operation. Thus, the arrays 58 of references in the master XZ table 57 for the XZ coordinates of (3,7), (4,7), (5,7), (6,7), may refer to [Y(7)45, Y(2)45], [Y(7)46, Y(2)46], [Y(7)47, Y(2)47], [Y(7)48, Y(6)48, Y(2)48], respectively. (For clarity, the rest of XZ locations in the master XZ table 57 each includes a Y array consisting of only one reference to a location in various part voxel sets.) In the illustrated example, Y array of references [Y(7)45, Y(2)45] refers to the Y coordinate value Y(7)45 associated with the part XZ table for the flap part (7) in FIG. 5C, and then refers to the Y coordinate value Y(2)45 associated with the part XZ table for the wing part (2) in FIG. 5A, in that order.

In this example, when the wing part (2) is complete (i.e., including both the flap parts (6) and (7)), an image of such wing part (2) may be rendered based on the master XZ table 57, by referencing the Y coordinates associated with the designated part XZ table and retrieving the attribute values associated with the referred-to Y coordinates. For example, XZ coordinates of (3,7), (4,7), (5,7), (6,7) within the master XZ table 57 refer to Y(7)45, Y(7)46, Y(7)47, Y(7)48, respectively, and therefore the attribute values associated with these Y coordinate values, all within the part XZ table for the flap part (7) of FIG. 5C, are used to render these voxels.

When the flap part (7) is to be detached, then the part voxel set 20L of FIG. 5C, which already completely defines the flap part (7), is used to render the detached flap part (7). Also, the master XZ table 57 is modified (updated) to represent the wing part (2) including the flap part (6), from which the flap part (7) has been detached. For example, any references that refer to the removed flap part (7) may be deactivated in the master XZ table 57, to thereby reveal (or activate) any references that are stored immediately subsequent to the deactivated references in the corresponding Y arrays. Thus, in this example, references to Y(7)45, Y(7)46, Y(7)47, Y(7)48, all referring to the Y coordinates associated with the part xZ table for the flap part (7), are deactivated. As a result, in the modified XZ table 59, the XZ coordinates of (3,7), (4,7), (5,7), (6,7) now include references to Y(2)45, Y(2)46, Y(2)47, Y(6)48, respectively, which are stored immediately subsequent to the deactivated references in the Y arrays 58. Then, the modified XZ table 59 is used to render the image of the wing part (2) including the flap part (6), by referencing the referred-to Y coordinates associated with the designated XZ table and retrieving the attribute values for the referred-to Y coordinates. For example, for XZ coordinates of (3,7), (4,7), (5,7) within the modified master XZ table 59, attribute values corresponding to Y(2)45, Y(2)46, Y(2)47, all associated with the part XZ table for the wing part (2) of FIG. 5A, are used to render these voxels, while for XZ coordinates of (6,7), attribute values corresponding to Y(6)48 associated with the part XZ table for the flap part (6) of FIG. 5B are used to render this voxel.

When the flap part (6) is to be detached from the wing part (2), then the part voxel set 20K of FIG. 5B, which already completely defines the flap part (6), is used to render the detached flap part (6). Also, since the voxel set 20J already completely defines the wing part (2), the voxel set 20J is used to render the wing part (2). Thus, in this example, there is no need to use or update the master XZ table. For the purpose of illustration, however, FIG. 5D shows an updated master XZ table 60, in which the XZ coordinates of (6,6), (7,6), (6,7), (7,7), which previously included references to Y(6)41, Y(6)42, Y(6)48, Y(6)49, now include references to Y(2)41, Y(2)42, Y(2)48, Y(2)49, respectively. As the updated master XZ table 60 consists only of references to the voxels for the wing part (2) of FIG. 5A, rendering based on the updated master XZ table 60 would produce the same result as rendering based on the part XZ table for the wing part (2) of FIG. 5A.

In various exemplary embodiments of the present invention, the master XZ table does not include all arrays of Y references to multiple part voxel sets that are arranged in the order of proper detachment or in the order of rendering. Rather, all references in the master XZ table are calculated each time a user requests to detach/re-attach a geometric part from/to an object. With these embodiments, the references may be re-calculated and adjusted to control the rendering priority of multiple geometric parts on a part-by-part basis. To update or modify the master XZ table and its associated arrays of Y references (based on a part detachment/re-attachment operation), a routine may be used that visits every column (at particular X and Z coordinates) in every part voxel set and updates a corresponding entry (in the corresponding column) of the master XZ table. Essentially, the routine is performed to identify all voxels in each column of each part voxel set that have Y coordinates corresponding to the column in the master XZ table resulting from the attachment/detachment operation. Then, references to those voxels are added to the corresponding array of Y references of the master XZ table.

As a specific example, assume that some part voxel sets have occupied voxels at the same geometric location. For example, assume that part voxel set A has a voxel at (0, 0, 0) and part voxel set B has voxels at (0, 0, 0) and (0, 0, 1). Assume further that part voxel sets A and B have the same size as the resulting object (after an attachment/detachment operation) to be rendered. Then, a master XZ table can be updated or modified as follows.

For every X and Z coordinates in part voxel set A, a routine processes its column data (that provide an array of Y coordinates), and for every Y coordinates in each column the routine checks if the corresponding column (at the same X and Z coordinates) of the master XZ table contains that Y. For example, if (x:0, z:0) of part voxel set A has a voxel with (y:0), the routine checks if (x:0, z:0) of the master XZ table already refers to a voxel with (y:0). As the routine has just started, the master XZ table is empty at this point, so the check results in no such reference found, and the routine adds a reference to the voxel at (x:0, z:0) with (y:0) in part voxel set A to the master XZ table. The routine repeats this process for all voxels in part voxel set A, and they all will be referenced in the master XZ table because part voxel set A is the first part voxel set processed and there can be no conflicts. After part voxel set A is processed, the routine then processes part voxel set B in a similar manner. At this time, when the routine considers (x:0, z:0) with (y:0) in part voxel set B, it finds that the master XZ table already refers to a voxel of part voxel set A at (x:0, z:0) with (y:0). Therefore, the routine rejects this voxel in part voxel set B and proceeds to next consider (y:1) at the same X and Z coordinates, (x:0, z:0). The master XZ table does not refer to any voxel at (0, 0, 1), so the routine will add a reference in the master XZ table to refer to the voxel at (0, 0, 1) in part voxel set B. As a result, the master XZ table now has two references to voxels: at (0, 0, 0) referring to a voxel of part voxel set A and at (0, 0, 1) referring to a voxel of part voxel set B.

Thus, essentially, for every part voxel set and for every column in each part voxel set, the routine checks if Y values in the column have been referred to in the master XZ table. The routine skips those voxels that are already referenced, and add those voxels that are not yet referenced.

Reattachment of previously detached parts is carried out in the manner reverse to the method described above. For example, if the flap part (7) is to be reattached to the wing part (2) and the flap part (6), then the master XZ table is updated from 59 to 57, as shown in FIG. 5D, by re-calculating references to Y(7)45, Y(7)46, Y(7)47, Y(7)48, in XZ coordinates of (3,7), (4,7), (5,7), (6,7), respectively.

FIG. 5F is a flow chart illustrating a method of organizing multiple geometric parts forming an object in 3D voxel data, using a number of part voxel sets (each defined by a part XZ table and a part attribute table) and a master XZ table. In step 61, a part voxel set is created for each geometric part. In step 62, a master XZ table with references is created. The references refer to Y coordinates in Y arrays associated with various part XZ tables, as described above.

FIG. 5G is a flow chart illustrating a routine of permitting a user to attach and/or reattach multiple geometric parts forming an object in 3D voxel data, using a number of part voxel sets and a master XZ table, in accordance with one embodiment of the present invention. In step 63, the routine receives a user request to detach a part. In step 64, a voxel set for the detached part is retrieved and rendered. In step 65, it is determined whether the rest of an object (from which the part has been detached) consists of a single part. If so, in step 66, a voxel set for the single (last) part is retrieved and rendered. On the other hand, if in step 65 it is determined that the rest of an object consists of two or more parts, then proceeding to step 67, a master XZ table is updated, in a manner described above, and the rest of the object is rendered based on the updated master XZ table. In step 68, it is determined whether the user has requested to reattach a part. If not, returning to step 63, the routine awaits to receive user's further request to detach another part. On the other hand, if in step 68 it is determined that the user has requested to re-attach a part, then proceeding to step 69, a master XZ table is updated in a reverse manner and an object (to which the part is reattached) is rendered based on the updated master XZ table.

As will be appreciated by one skilled in the art, the present approach based on the use of multiple part voxel sets and a master XZ table eliminates the Swiss cheese problem because each of the part voxel sets fully defines each part, and further because the master XZ table may be constructed to refer to the various parts in a manner corresponding to how these parts are actually arranged. In some embodiments of the present invention, the various parts are not necessarily pre-arranged in the order of detachment, and a user may readily detach/reattach parts in any unspecified order and render any parts in any unspecified order. For example, the user may control rendering priorities on a voxel level (e.g., which of multiple part voxels sharing one voxel space should be rendered first) by adjusting the master XZ table. In this connection, note that the independent/dependent voxel sets approach described above in reference to FIGS. 3A-3C permits the user to readily control rendering priorities on a voxel level. Specifically, the user may arrange the voxel information in independent/dependent voxel sets in the order of preferred rendering priorities—the farther away from an independent voxel set, the less rendering priority a dependent voxel set receives.

According to the present approach using a master XZ table, the part detachment speed is very fast because detachment of each part does not involve any voxel copying/deleting, and instead involves merely updating the master XZ table (e.g., by traversing their Y reference arrays, i.e., the arrays of references to Y coordinate values). The fast detachment speed is also due to the fact that each of the detachable parts is fully defined as a voxel set at the outset, and therefore only the object from which each part is detached or reattached needs to be adjusted or modified during any detachment/reattachment operation. Furthermore, since each part is fully defined in its own part voxel set in terms of a part XZ table and a part attribute table, there is no need to explicitly store a part number as part of the attribute values for each voxel defining the part. As the master XZ table may refer to different part voxel sets, and hence to different part attribute values, the memory locations to be traversed during rendering may not be contiguous (e.g., a y location for the part (2) is rendered, then a y location for the part (6) is rendered, etc.). Although this may lower the cache hits rate to slightly slow down the rendering speed, any such slowing is almost negligible in most rendering applications.

While the preferred embodiments of the invention have been illustrated and described, numerous variations in the illustrated and described arrangements of systems, components, and sequences of operations will be apparent to one skilled in the art based on this disclosure. Various aspects of the invention may be used separately, or in combinations, or in sequences other than those explicitly disclosed. Thus, it will be appreciated that various changes can be made therein without departing from the spirit and scope of the invention.

The embodiments of the invention in which an exclusive property or privilege is claimed are defined as follows:

1. A method of organizing multiple geometric parts forming an object in 3D voxel data, comprising:
creating a part voxel set for each geometric part, each part voxel set comprising a part XZ table defining geometric locations of all occupied voxels within the part voxel set and an attribute table defining attribute values for all occupied voxels within the part voxel set, wherein multiple part voxel sets created for the multiple geometric parts share one 3D space; and
creating a master XZ table in the same 3D space shared by the multiple part voxel sets, the master XZ table defining geometric locations within the multiple part voxel sets based on Y references to the geometric locations within the multiple part voxel sets.

2. The method of claim 1, wherein the Y references are arranged in arrays of the master XZ table in a predefined order of detaching the multiple geometric parts.

3. The method of claim 1, wherein multiple attribute tables for multiple part voxel sets are combined in a single attribute table for the object.

4. A computer-readable tangible medium comprising computer-executable instructions which, when loaded onto a computer, perform the method of claim 1.

5. A method of permitting a user to detach and/or reattach multiple geometric parts forming an object in 3D voxel data, wherein: (i) each geometric part is predefined by a part voxel set comprising a part XZ table defining geometric locations of all occupied voxels within the part voxel set and an attribute table defining attribute values for all occupied voxels within the part voxel set, (ii) multiple part voxel sets predefined for the multiple geometric parts share one 3D space, (iii) and a master XZ table is predefined in the same 3D space shared by the multiple part voxel sets, the master XZ table defining geometric locations within the multiple part voxel sets based on Y references to the geometric locations within the multiple part voxel sets, the method of permitting a user to detach and/or reattach multiple geometric parts comprising:
(a) receiving a user request to detach a first geometric part from the rest of the object;
(b) retrieving a first part voxel set defining the first geometric part;
(c) rendering the first geometric part based on the retrieved first part voxel set;
(d) updating the master XZ table by replacing any Y references to the geometric locations within the first part voxel set defining the first geometric part with new Y references; and
(e) rendering the rest of the object based on the updated master XZ table.

6. A computer-readable tangible medium comprising computer-executable instructions which, when loaded onto a computer, perform the method of claim 5.

7. The method of claim 5, further comprising:
(f) receiving a user request to detach a second geometric part from the rest of the object;
(g) retrieving a second part voxel set defining the second geometric part;
(h) rendering the second geometric part based on the retrieved second part voxel set;
(i) if the rest of the object consists of a single geometric part, retrieving a part voxel set defining the single geometric part and rendering the same based on the retrieved part voxel set;
(j) if the rest of the object consists of more than one geometric part, updating the master XZ table by replacing any Y references to the geometric locations within the second part voxel set defining the second geometric part with new Y references, and rendering the rest of the object based on the updated master XZ table.

8. A computer-readable tangible medium comprising computer-executable instructions which, when loaded onto a computer, perform the method of claim 7.

9. The method of claim 5, further comprising:
(j) receiving a user request to reattach the first geometric part to the rest-of the object;
(k) updating the master XZ table by re-calculating Y references to refer to the geometric locations within the first part voxel set defining the first geometric part; and
(l) rendering the object based on the updated master XZ table.

10. A computer-readable tangible medium comprising computer-executable instructions which, when loaded onto a computer, perform the method of claim 9.

11. A method of organizing multiple geometric parts forming an object in 3D voxel data, comprising:
creating an independent voxel set for an object, the voxel set comprising a geometric data set defining geometric locations of all occupied voxels within the independent voxel set and an attribute table defining attribute values for all occupied voxels within the independent voxel set, wherein at least one voxel is occupied by first and second geometric parts and is assigned to the first geometric part; and
creating a first dependent voxel set, the first dependent voxel set comprising a dependent geometric data set defining at least one geometric location of the at least one voxel occupied by the first and second geometric parts in the independent voxel set and an attribute table defining attribute values for the at least one geometric location as assigned to the second geometric part.

12. The method of claim 11, wherein at least one voxel in the independent voxel set is occupied by first, second, and third geometric parts and is assigned to the first geometric part, the method further comprising:
creating a second dependent voxel set, the second dependent voxel set comprising a dependent geometric data set defining at least one geometric location of the at least one voxel occupied by the first, second, and third geometric parts in the independent voxel set and an attribute table defining attribute values for the at least one geometric location as assigned to the third geometric part.

13. A computer-readable tangible medium comprising computer-executable instructions which, when loaded onto a computer, perform the method of claim 11.

14. A method of permitting a user to detach and/or reattach multiple geometric parts forming an object in 3D voxel data, wherein (i) an independent voxel set is predefined for an object, the independent voxel set comprising a geometric data set defining geometric locations of all occupied voxels within the independent voxel set and an attribute table defining attribute values for all occupied voxels within the independent voxel set, (ii) at least one voxel in the independent voxel set is occupied by first and second geometric parts and is assigned to the first geometric part, and (iii) a dependent voxel set is created, the dependent voxel set comprising a dependent geometric data set defining at least one geometric location of the at least one voxel occupied by the first and second geometric parts in the independent voxel set and an attribute table defining attribute values for the at least one geometric location as assigned to the second geometric part, the method of permitting a user to detach and/or reattach multiple geometric parts comprising:
(a) receiving a user request to detach a first geometric part from the rest of the object;
(b) copying all voxels assigned to the first geometric part in the independent voxel set and in the dependent voxel set to create a new part voxel set corresponding to the first geometric part;
(c) rendering the first geometric part based on the newly created part voxel set corresponding to the first geometric part;
(d) removing all voxels assigned to the first geometric part from the independent voxel set and the dependent voxel set;
(e) rendering the rest of the object based at least on the independent voxel set.

15. A computer-readable tangible medium comprising computer-executable instructions which, when loaded onto a computer, perform the method of claim 14.

16. The method of claim 14, further comprising:
(f) receiving a user request to detach a second geometric part from the rest of the object;
(g) copying all voxels assigned to the second geometric part in the independent voxel set and in the dependent voxel set to create a new part voxel set corresponding to the second geometric part;
(h) rendering the second geometric part based on the newly created part voxel set corresponding to the second geometric part;
(i) removing all voxels assigned to the second geometric part from the independent voxel set and the dependent voxel set;
(i) rendering the rest of the object based at least on the independent voxel set.

17. The method of claim 14, further comprising:
(k) receiving a user request to reattach the first geometric part to the rest of the object;
(l) copying all voxels in the newly created part voxel set corresponding to the first geometric part back into the independent voxel set and the dependent voxel set, and deleting the newly created part voxel set;
(m) rendering the object based on the independent voxel set.

18. A computer-readable tangible medium comprising computer-executable instructions which, when loaded onto a computer, perform the method of claim 17.

19. A method of permitting a user to detach and/or reattach multiple geometric parts forming an object in 3D voxel data, wherein a voxel set is predefined for an object, the voxel set comprising a geometric data set defining geometric locations of all occupied voxels within the voxel set and an attribute table defining attribute values including part numbers for all occupied voxels within the independent voxel set, the method of permitting a user to detach and/or reattach multiple geometric parts comprising:
(a) receiving a user request to detach a first geometric part from the rest of the object;
(b) instancing the voxel set to create a first instance voxel set comprising a reference to the original voxel set;
(c) hiding in the first instance voxel set voxels that do not belong to the first geometric part;
(d) rendering the first geometric part based on the first instance voxel set;
(e) hiding in the original voxel set voxels that belong to the first geometric part; and
(f) rendering the rest of the object based on the original voxel set.

20. A computer-readable tangible medium comprising computer-executable instructions which, when loaded onto a computer, perform the method of claim 19.

21. The method of claim 19, further comprising:
(g) receiving a user request to reattach the first geometric part to the rest of the object;
(h) marking as visible those voxels in the original voxel set that belong to the first geometric part; and
(i) rendering the object based on the original voxel set.

22. A computer-readable tangible medium comprising computer-executable instructions which, when loaded onto a computer, perform the method of claim 21.
